(19) United States
(12) Patent Application Publication
(10) Pub. No.: US 2026/0163322 A1
(43) Pub. Date: Jun. 11, 2026

(54) LASER SYSTEM WITH MONOLITHIC OPTICAL COLLIMATION AND CIRCULARISATION DEVICE

(71) Applicant: AMPLITUDE, PESSAC (FR)

(72) Inventor: Florent BASIN, PESSAC (FR)

(21) Appl. No.: 19/126,846

(22) PCT Filed: Nov. 7, 2023
(86) PCT No.: PCT/EP2023/081008

§ 371 Date: May 2, 2025

(30) Foreign Application Priority Data
Nov. 7, 2022 (FR) FR2211576

(51) Int. Cl. H01S 3/00; G02B 3/06; G02B 27/30; H01S 3/06; H01S 3/16

(52) U.S. Cl. CPC H01S 3/005; G02B 3/06; G02B 27/30; H01S 3/0606; H01S 3/1643

(57) ABSTRACT

The invention relates to a laser system (1) comprising a solid amplifying medium (2) capable of emitting an amplified beam (4) in a propagation direction (D), the amplified beam having a first angle of divergence in a first plane (Px) including the propagation direction, and a second angle of divergence in a second plane including the propagation direction and separate from the first plane, the second angle of divergence being separate from the first angle of divergence; and an optical device (3).

According to the invention, the optical device comprises a lens (31) arranged so as to refract the amplified beam into an outgoing beam (5), the lens having a first radius of curvature in the first plane and a second radius of curvature in the second plane, the second radius of curvature being separate from the first radius of curvature.

### TECHNICAL FIELD

The present invention generally relates to the technical field of optics.

It more particularly relates to a laser system.

The invention finds a particularly advantageous application in the making of laser systems based on a slab amplifying medium.

### TECHNOLOGICAL BACKGROUND

A laser system (“light amplification by stimulated emission of radiation”) conventionally comprises an amplifying medium, e.g. solid, designed to emit a spatially and temporally coherent light beam. Such a beam is often also referred to as a “laser”.

In the case of an amplifying medium having no symmetry of revolution with respect to the axis of propagation, the emitted light beam is often astigmatic. The light beam can then have different angles of divergence or of aperture in different planes including the direction of propagation of the beam. Therefore, the light beam exiting from a solid amplifying medium without symmetry of revolution is often elliptic and/or astigmatic.

To make this light beam circular (ellipticity close to 1), or simply stigmatic, and less divergent (collimated), the laser systems comprise optical beam-shaping devices. Such an optical device generally requires three or four lenses refracting successively the light beam. Some lenses have for role to circularize the beam by each modifying the beam divergence in a given direction, whereas other lenses make it possible to collimate the beam and correct the intrinsic astigmatism or that caused by the different lenses. However, such optical beam-shaping devices are expensive, complex to adjust and take up a lot of space.

### SUMMARY OF THE INVENTION

In this context, the present invention proposes a laser system comprising:
a solid amplifying medium capable of emitting an amplified beam along a propagation direction, the amplified beam having a first angle of divergence in a first plane including the propagation direction, and a second angle of divergence in a second plane including the propagation direction and distinct from the first plane, the second angle of divergence being distinct from the first angle of divergence; and
an optical device comprising a lens arranged so as to refract the amplified beam into an outgoing beam, the lens having a first radius of curvature in the first plane and a second radius of curvature in the second plane, the second radius of curvature being distinct from the first radius of curvature.

Thus, thanks to the invention, the optical beam-forming device is simplified. Indeed, the lens implemented by the optical device makes it possible to modify simultaneously the two angles of divergence of the incident beam. Therefore, the amplified beam can be circularized and collimated by a reduced number of lenses, preferably by a single lens.

Therefore, although it offers less freedom of adjustment, the optical shaping device of the laser system according to the invention is inexpensive, easy to adjust and takes up very little space.

In the laser system according to the invention, a single lens can then replace a complex optical shaping system consisted of at least three or four lenses. The lens is then manufactured to correct the defects of a particular laser system, and although it offers fewer possibilities of adjustment, it limits the risk of misalignment.

Other non-limiting and advantageous features of the laser system according to the invention, taken individually or according to all the technically possible combinations, are the following:
the outgoing beam has two angles of divergence in the first plane and in the second plane, respectively, and the first radius of curvature and the second radius of curvature are determined, on the basis of the first angle of divergence and the second angle of divergence, so as to meet at least one of the following criteria: a difference between the two angles of divergence of the outgoing beam is less than a first threshold value, at least one among the two angles of divergence of the outgoing beam is less than a second threshold value;
the first radius of curvature and the second radius of curvature are determined in such a way that the outgoing beam is less astigmatic than the amplified beam;
the amplified beam has a circularity section perpendicular to the propagation direction in which the amplified beam is circular in shape, and the lens is positioned in such a way as to intersect the circularity section;
the first plane in perpendicular to the second plane;
between the amplifying medium and the optical shaping device, the amplified beam is divergent in the first plane and convergent in the second plane;
the lens comprises a first optical face forming the first radius of curvature and a second optical face, opposite to the first optical face, forming the second radius of curvature;
at least one among the first optical face and the second optical face extends along a cylindrical surface of revolution;
the lens comprises a first flat optical face and a second optical face, opposite to the first optical face, forming the first radius of curvature and the second radius of curvature;
the second optical face extends along a toroidal surface;
the first radius of curvature and the second radius of curvature are each between 1 mm and 1000 mm;
the amplified beam comprises a central wavelength, and the lens comprises optical faces whose roughness is less than a quarter of the central wavelength;
the lens is made of a silica with an absorption of less than 10⁻⁵ cm⁻¹ for a wavelength of between 900 nm and 1100 nm;
the amplified beam has a Gaussian profile in a transverse direction perpendicular to the propagation direction;
the optical shaping device is consisted of the lens;
the lens has a thickness, in the propagation direction, of between 2 mm and 4 mm;
the lens is made from electronic grade silica;
the lens is arranged in such a way that the amplified beam illuminates a region of the lens with a surface area of between 9 mm² and 40,000 mm²; the lens comprises at least one of the coatings with a reflectance at normal incidence of less than 0.1 % at 1030 nm;
the amplified beam is a pulse beam whose emission duration is between 100 fs and 20 ns;
the solid amplifying medium comprises a rectangular parallelepiped crystal and the lens is positioned opposite an exit edge of the crystal.

Obviously, the different features, alternatives and embodiments of the invention can be associated with each other according to various combinations, insofar as they are not incompatible or exclusive with respect to each other.

### DETAILED DESCRIPTION OF THE INVENTION

The following description in relation with the appended drawings, given by way of non-limiting examples, will allow a good understanding of what the invention consists of and of how it can be implemented.

In the Appended Drawings:

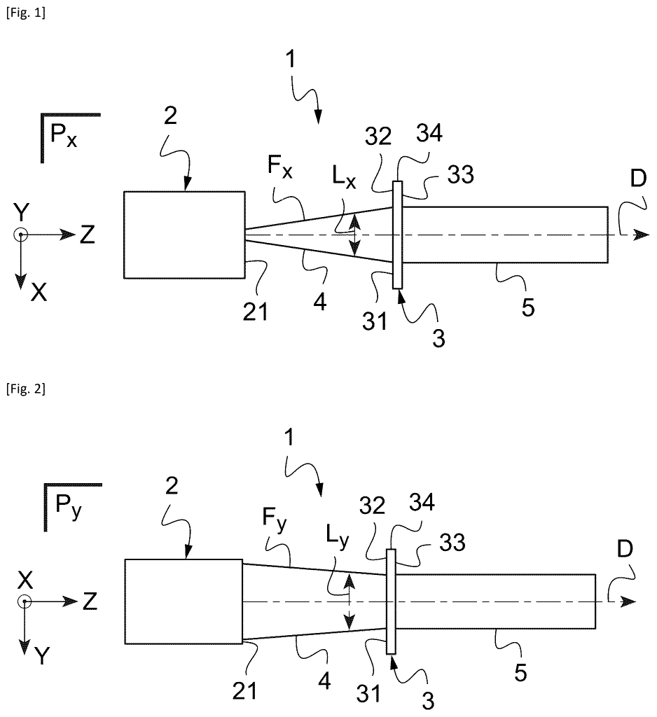

FIG. 1 is a schematic cross-sectional view, in a first plane, of the laser system according to the invention;

FIG. 2 is a schematic cross-sectional view, in a second plane, of the laser system of FIG. 1;

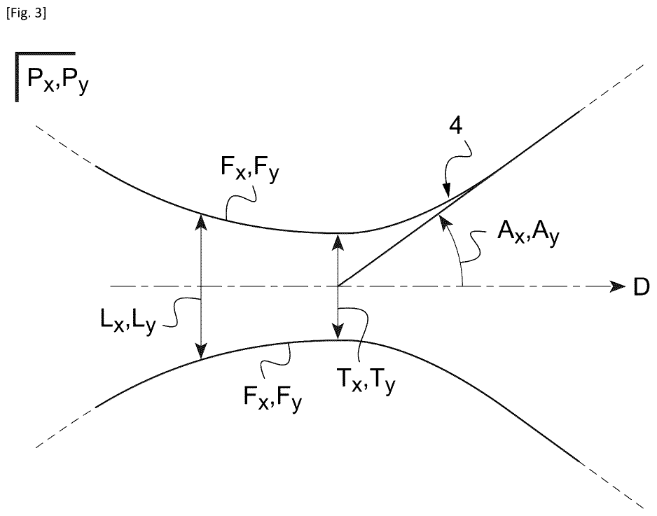

FIG. 3 is a schematic cross-sectional view, in the first plane, of a part of a light beam generated by the laser system of FIG. 1;

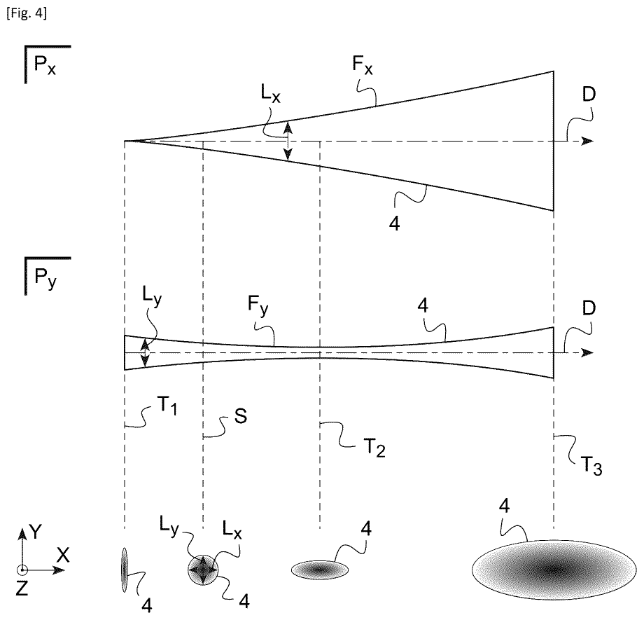

FIG. 4 is a schematic view of the light beam generated by the laser system propagating freely in each of the planes of FIGS. 1 and 2 as well as in transverse planes;

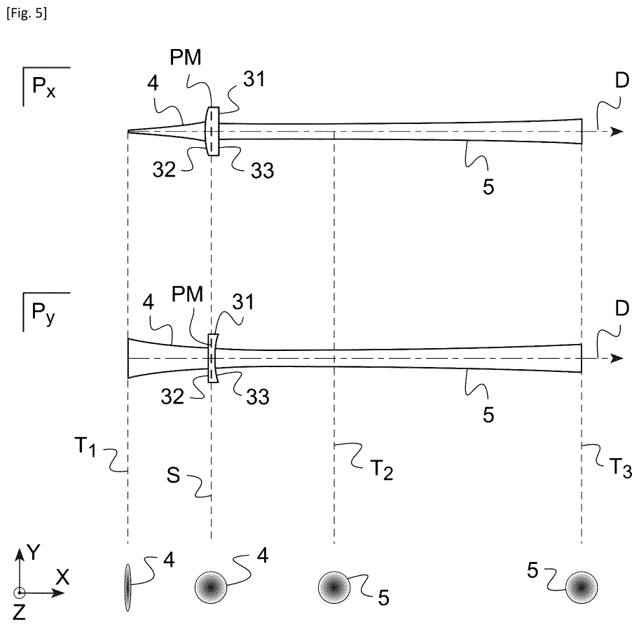

FIG. 5 is a schematic view of the light beam of FIG. 4 refracted into an outgoing beam by a lens, implemented in the laser system of FIG. 1, according to a first embodiment of the invention;

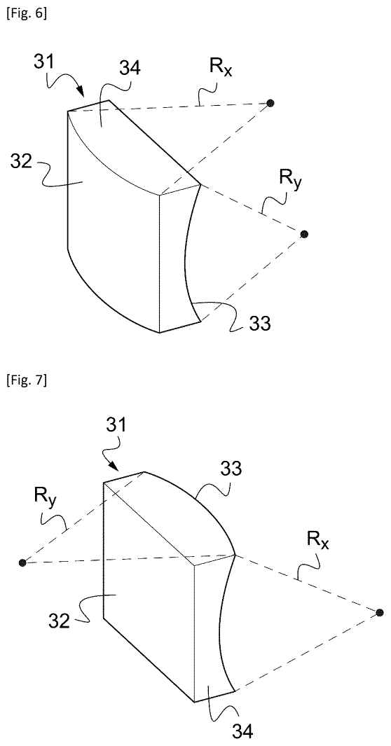

FIG. 6 is a schematic perspective view of the lens of FIG. 5;

FIG. 7 is a schematic perspective view of a second embodiment of a lens implemented in the laser system of FIG. 1.

A laser system 1 according to the invention is shown in FIGS. 1 and 2. As shown in FIG. 1 or 2, the laser system 1 comprises an amplifying medium 2 and an optical device 3. The laser system 1 is referred to as a “laser” in the sense that it makes it possible to produce a high-intensity light beam that is spatially and temporally coherent. The laser system 1 is more specifically of any pulse type and based on a crystalline amplifying medium. The laser system can for example be used for laser cutting.

The laser system 1 is for example designed to generate a pulse light beam whose energy is between 10 W and 10 kW at frequencies varying between 50 kHz and 40 MHz. The duration of emission is for example of between 100 fs et 1 ns. The light beam power is for example of between 1 μJ and 10 mJ.

As shown in FIGS. 1 and 2, the amplifying medium 2 is capable of emitting a laser light beam called the amplified beam 4 hereinafter. For that purpose, the amplifying medium 2, which is here solid, is optically pumped to cause the constituent atoms to enter an excited state. Conventionally, the laser system 1 comprises an optical cavity (not shown), which comprises for example two mirrors, within which the amplifying medium 2 is placed. Therefore, a precursor beam (not shown) injected into the optical cavity passes through the amplifying medium 2 several times, which produces, by stimulated emission, the amplified beam 4.

The amplifying medium 2 is here of parallelepiped shape, e.g. a rectangle. The entry and exit faces of the amplifying medium may also be wedge-shaped, i.e. non-parallel, in order to avoid return travels in the amplifying medium 2. The amplifying medium 2 has more specifically a slab shape, the precursor beam being injected via an edge of the slab, perpendicular to the thickness of the slab, i.e. the smallest dimension thereof. The amplifying medium 2 has for example a width between 5 mm and 30 mm, a length between 5 mm and 30 mm and a thickness between 0.3 mm and 2 mm.

The amplifying medium 2 is for example made of neodymium-doped yttrium aluminium garnet (Nd:YAG) or ytterbium-doped yttrium aluminium garnet (Yb:YAG). The amplified beam 4 has a central wavelength, whose intensity is maximum, which is for example of between 1000 nm and 1100 nm. The central wavelength depends on the material of which the amplifying medium 2 is made. Therefore, for example, for an amplifying medium made of Yb:YAG, the central wavelength is of 1030 nm and for an amplifying medium made of Nb:YAG, the wavelength is of 1064 nm.

The amplified beam 4 is emitted by the amplifying medium 2 in a propagation direction D here corresponding to the Z-axis of an orthonormal XYZ coordinate system. The incident beam 4 has a width that is defined along a direction perpendicular to the propagation direction D, corresponding for example to the X-axis or the Y-axis of the orthonormal XYZ coordinate system, as:
a segment for which, at the central wavelength, the intensity is higher than half the maximum intensity, such a segment corresponding to a full width at half-maximum;
a segment for which, at the central wavelength, the intensity is higher than the maximum intensity divided by e²; or
a segment for which the energy is higher than 86% of the total energy of the incident beam 4.

Hereinafter, the width of the amplified beam 4 is defined as the full width at half-maximum.

The geometry of the amplifying medium 2 gives astigmatism to the amplified beam 4. In an amplifying medium 2 whose exit edge 21 is rectangular, the divergence in the narrow width of the edge is mainly guided by the gain of the amplifying medium and the divergence in the large width is mainly guided by the radii of curvature of the mirrors forming the optical cavity.

Here, the amplified beam 4 has more specifically a first angle of divergence Ax in a first plane Px that includes the propagation direction D, and a second angle of divergence in a second plane Py that also includes the propagation direction D and that is distinct from the first plane Px. The mathematical term “include” here means that the propagation direction D is included, i.e. extends, in the first plane Px and in the second plane Py. Here, the first angle of divergence Ax is distinct from the second angle of divergence Ay.

Hereinafter, as shown in FIG. 1, a first width Lx of the incident beam 4 is defined as the width of the incident beam 4 along a direction perpendicular to the propagation direction D and included in the first plane Px. Likewise, as shown in FIG. 2, a second width Ly of the incident beam 4 is defined as the width of the incident beam 4 along a direction perpendicular to the propagation direction D and included in the second plane Px.

Each angle of divergence Ax, Ay is an angle representative of width variation of the amplified beam 4 along the propagation direction D in its respective plane Px, Py. As shown in FIG. 3, the first angle of divergence Ax is representative of the variation of the first width Lx and the second angle of divergence Ay is representative of the variation of the second width Ly. Each angle of divergence Ax, Ay is for example defined as in the ISO11146 standard.

More particularly, as shown in FIG. 3, the first angle of divergence Ax is here defined, in the first plane Px, as the half-angle between a first circumference Fx of the amplified beam 4 and the propagation direction D, measured at a first size Tx of the incident beam 4, i.e. at the focus point of the amplified beam 4 in the first plane Px, where the first width Lx is minimum. As shown in FIG. 3, the first circumference Fx represents the variation of the first width Lx in the first plane Px.

The second angle of divergence Ay is here defined in same way in the second plane Py as the half-angle between the second circumference Fy of the amplified beam 4 and the propagation direction D, measured at a second size Ty of the incident beam 4, i.e. at the focus point of the amplified beam 4 in the second plane Py, where the second width Ly is minimum, the second circumference Fy representing the variation of the second width Ly in the second plane Py.

The amplified beam 4 being astigmatic, its first size and its second size are spatially separated from each other, they are for example 1 mm to 10,000 mm apart from each other along the propagation direction D.

Due to its astigmatism, the amplified beam 4 has a section, perpendicular to the propagation direction D, which is generally elliptic between the amplifying medium 2 and the optical device 3.

Here, as shown in FIG. 4, the first plane Px and the second plane Py are defined in such a way as to be perpendicular to each other. As shown in FIGS. 1 and 2, the first plane Px here corresponds to the XZ plane of the orthonormal XYZ coordinate system and the second plane Py corresponds to the YZ plane of the orthonormal XYZ coordinate system.

The first plane Px and the second plane Py are more particularly defined so as to correspond to the major and minor axes of the elliptical section of the incident beam 4 in a transverse plane T1, T2, T3 perpendicular to the propagation direction D.

In the example illustrated in FIG. 4, the amplified beam 4 is elliptical with the major axis included in the second plane Py at a first transverse plane T1, then elliptical with the major axis included in the first plane Px at a second transverse plane T2 and a third transverse plane T3. The first transverse plane T1 here corresponds to that of the exit edge 21 of the amplifying medium 2.

Here, perpendicularly to the propagation direction D, i.e. along transverse directions perpendicular to the propagation direction D, e.g. along the X and Y axes of the orthonormal XYZ coordinate system, the amplified beam 4 generally has a Gaussian profile of intensity at the central wavelength.

The optical device 3 is adapted to shape the amplified beam 4 in that it makes it possible to modify geometrical characteristics of the amplified beam 4.

As shown in FIGS. 1 and 2, the optical device 3 comprises a lens 31 arranged along the propagation direction D. The lens 31 is here positioned opposite the exit edge 21 of the amplifying medium 2 through which the amplified beam 4 is emitted. Therefore, the lens 31 refracts the amplified beam 4 into an outgoing beam 5. The outgoing beam 5 also has an angle of divergence in the first plane Px, called the primary angle of divergence, and an angle of divergence in the second plane Px, called the secondary angle of divergence. The angles of divergence of the outgoing beam 5 are defined in the same way as those of the incident beam 4.

Remarkably, the lens 31 has two different radii of curvature in two distinct planes. In other words, the lens 31 is a bifocal lens. Each of the radii of curvature Rx, Ry is associated with a strictly positive, i.e. non-zero, curvature. The lens 31 is directed so as to have a first radius of curvature Rx in the first plane Px and a second radius of curvature Ry in the second plane Py.

By determining the first radius of curvature Rx and the second radius of curvature Ry on the basis of the first angle of divergence Ax and the second angle of divergence Ay, the lens 31 is adapted to circularize or collimate the outgoing beam 5. Preferably, the lens 31 is adapted to circularize and collimate the outgoing beam 5.

The effect of the lens 31 on the amplified beam 4 is shown in FIG. 5, in comparison with FIG. 4 in which a free propagation of the amplified beam 4 is illustrated. In FIG. 4, i.e. without the lens 31, the amplified beam 4 is elliptical in the second transverse section T2 and in the third transverse section T3 and diverge because the first length Lx and the second length Ly increase between the second transverse section T2 and the third transverse section T3. In FIG. 5, the outgoing beam 5 is circular in shape, as shown in the second transverse section T2 and in the third transverse section T3. The outgoing beam 5 is thus also stigmatic. Moreover, the outgoing beam 5 is collimated because its diameter is substantially equal in the Rayleigh area, for example here in the second transverse section T2 and in the third transverse section T3.

Therefore, the outgoing beam 5 can be shaped using only the lens 31. The lens 31 is thus preferably specifically designed with respect to the shape of the amplified beam 4. The adjustment of the optical device 3 is simple because the latter is here consisted of a single optical element: the lens 31. On the other hand, the design of the lens 31 depends on the amplified beam 4 and thus on the amplifying medium 2.

The first radius of curvature Rx and the second radius of curvature Ry can be determined in such a way as to optimize the circularity of the outgoing beam 5, i.e. so as to make a section of the outgoing beam 5 circular in a plane perpendicular to the propagation direction D. The circularity of a laser beam is here defined according to the ISO11146 standard. Therefore, a beam is considered as being circular when its ellipticity is higher than 87%.

The first radius of curvature Rx and the second radius of curvature Ry are thus determined so as to minimize a difference between the primary angle of divergence and the secondary angle of divergence of the outgoing beam 5. In practice, the radii of curvature Rx, Ry of the lens 31 are then determined so that the difference between the primary angle of divergence and the secondary angle of divergence is less than a first threshold value. The first threshold value is for example less than 0.1 mrad.

The first radius of curvature Rx and the second radius of curvature Ry can be determined in such a way as to minimize the divergence of the outgoing beam 5, i.e. to minimize the widening of the outgoing beam 5. In other words, the first radius of curvature Rx and the second radius of curvature Ry are determined so as to minimize the primary angle of divergence or the secondary angle of divergence. Preferably, the radii of curvature Rx, Ry of the lens 31 are determined so as to minimize both the primary angle of divergence and the secondary angle of divergence. In practice, the radii of curvature Rx, Ry of the lens 31 are then determined so that the primary angle of divergence and/or the secondary angle of divergence is less than a second threshold value. The second threshold value is for example between 0.1 μrad and 2 mrad.

Of course, the value of the radii of curvature Rx, Ry also depend on the optical index of the lens 31. The lens 31 can therefore be designed in terms of focal lengths, which are then converted into radii of curvature, for example according to the following formula: R=f·(n−1) where R is the radius of curvature, f the desired focal length and n the optical index of the lens.

Moreover, thanks to the lens 31, the outgoing beam 5 is less astigmatic than the amplified beam 4.

As shown in FIG. 4, although the amplified beam 4 is astigmatic, the latter has a circularity section S, perpendicular to the propagation direction D, in which the amplified beam 4 is circular. Before and after this circularity section S, the incident beam 4 is elliptical.

As can be seen in FIG. 5, remarkably, the lens 31 is positioned so as to intersect the circularity section S. This makes it possible to improve the combined effect of collimation and circularization of the lens 31. The lens 31 is here designed to operate in the circularity section S.

In the example illustrated in FIGS. 1, 2 and 5, between the amplifying medium 2 and the lens 31, the amplified beam 4 is divergent in the first plane Px and convergent in the second plane Py. Such an amplified beam is typically generated by the Slab Laser systems. In these systems, the small width of the slab edge is included in the first plane Px and the large width of the slab edge is included in the second plane Py.

As shown in FIG. 4, at the exit of the amplifying medium 2, the first width Lx is then increasing whereas the second width Ly is decreasing along the propagation direction D. As schematized in FIG. 4, the circularity section S then corresponds to the plane, perpendicular to the propagation direction D, in which the first width Lx is equal to the second width Ly. Here, the amplified beam 4 is therefore circular in the circularity section S. Upstream from the circularity section S, the incident beam 4 is elliptical with the major axis in the second plane Py and, downstream from the circularity section S, the incident beam 4 is elliptical with the major axis in the first plane Px.

Therefore, as illustrated in FIG. 5, to circularize and collimate the outgoing beam 5, the first radius of curvature Rx is associated with a positive focal length, in that the associated image focus is located downstream from the lens 31 along the propagation direction, i.e. on the side of the outgoing beam 5. On the contrary, the second radius of curvature Ry is associated with a negative focal length, in that the associated image focus is located upstream from the lens 31 along the propagation direction, i.e. on the side of the amplified beam 4.

Therefore, thanks to the lens 31 directed so as to have the first radius of curvature Rx in the first plane Px and the second radius of curvature Ry in the second plane Py and positioned in the circularity section S, the outgoing beam 5 is here circular and collimated. In FIG. 5, the diameter of the outgoing beam 5 is thus wholly constant up to the third transverse plane T3, in the Rayleigh zone.

As can be seen in FIGS. 1 and 2, the lens 31 comprises two opposite optical faces. The lens 31 more particularly comprises a first optical face 32 illuminated by the amplified beam 4 and a second optical face 33 from which the outgoing beam 5 is emitted. In other words, the first optical face 32 is directed towards the amplifying medium 2 and the second optical face 33 is directed away from the amplifying medium 2. Here, the optical faces 32, 33 are arranged perpendicularly to the propagation direction D. The lens 31 is arranged so that the amplified beam 4 illuminates a surface of the first optical face 32, of between 0.2 mm² and 40,000 mm², for example of between 9 mm² and 10,000 mm². Advantageously, the lens 31 has small optical faces 32, 33, for example of between 0.2 mm² and 100 mm², which makes it less expensive and less bulky.

The lens 31 has for example a thickness of between 2 mm and 4 mm. The thickness of the lens 31 may correspond to its size along the propagation direction D or also at the smallest distance between the first optical face 32 or the second optical face 33.

The lens 31 also comprises a peripheral edge 34 connecting the optical faces 32, 33. The peripheral edge 34 can for example have a square profile perpendicularly to the propagation of the amplified beam 4, as shown in FIGS. 5 and 6, or a circular profile.

In a first embodiment shown in FIGS. 5 and 6, each optical face 32, 33 forms one of the radii of curvature Rx, Ry, respectively.

Therefore, here, the first optical face 32 forms the first radius of curvature Rx and the second optical face 33 forms the second radius of curvature Ry. This means that the intersection between the first optical face 32 and the first plane Px defines an arc of a circle whose radius of curvature is equal to the first radius of curvature Rx. Likewise, this means that the intersection between the second optical face 32 and the second plane Px defines an arc of a circle whose radius of curvature is equal to the second radius of curvature Ry.

Of course, equivalently, the first optical face 32 can form the second radius of curvature Ry and the second optical face 33 can form the first radius of curvature Rx.

Advantageously, in this embodiment, the lens 31 can be manufactured in a simple and cheap manner, and with a great precision. The radii of curvatures Rx, Ry are thus designed with a tolerance of less than 1%.

Indeed, as can be seen in FIG. 6, each optical face 32, 33 here extends along a cylindrical surface of revolution. In other words, the first optical face 32 corresponds to a part of the cylindrical face of a cylinder of revolution whose radius is equal to the first radius of curvature Rx. Likewise, the second optical face 33 corresponds to a part of the cylindrical face of a cylinder of revolution whose radius is equal to the second radius of curvature Ry.

Here, the first plane Px being perpendicular to the second plane Py, the optical faces 32, 33 extend along cylindrical surfaces of revolution whose axes are oriented orthogonally to each other. In other words, the first optical face 32 corresponds to a part of the cylindrical face of a cylinder of revolution whose axis is included in the second plane Py. Likewise, the second optical face 32 corresponds to a part of the cylindrical face of a cylinder of revolution whose axis is included in the first plane Px.

The above-mentioned cylindrical face parts here depend on the shape of the peripheral edge 34, they are thus square or circular, for example.

As an alternative of this first embodiment, one of the optical faces can extend along a cylindrical surface of revolution whereas the other optical face extends along a spherical surface.

In this first embodiment, to shape the amplified beam 4 shown in FIGS. 1 and 2 (which is divergent in the first plane Px and convergent in the second plane Py), the first optical face 32 is convex and the second optical face 33 is concave. Of course, equivalently, when the first optical face 32 forms the second radius of curvature Ry and the second optical face 33 forms the first radius of curvature Rx, the first optical face 32 is concave and the second optical face is convex.

In this first embodiment, the lens 31 has a mean plane PM located halfway between the optical faces 32, 33. This mean plane PM is, for example, the plane most closely matched to the optical faces 32, 33 by first-order regression. Preferably, the mean plane PM of the lens 31 is merged with the circularity section S of the incident beam 4, as illustrated in FIG. 5. This makes it possible to improve the combined effect of collimation and circularization of the lens 3.

In a second embodiment shown in FIG. 7, one of the optical faces 32, 33 is flat and the other optical face 32, 33 forms the first radius of curvature Rx and the second radius of curvature Ry.

In the example illustrated in FIG. 7, the first optical faces 32 is flat and the second optical face 33 forms both the first radius of curvature Rx and the second radius of curvature Ry. This means that the intersection between the second optical face 33 and the first plane Px defines an arc of a circle whose radius of curvature is equal to the first radius of curvature Rx and that the intersection between the second plane Py defines an arc of a circle whose radius of curvature is equal to the second radius of curvature Ry.

Advantageously, in this second embodiment, the lens 31 is placed so that the second optical face 33 intersects the circularity section S. Preferably, the lens 31 is placed so that the circularity section S is merged with a mean plane of the second optical face 33. The mean plane of the second optical face 33 is for example the plane tangent to the second optical face 33 at the centre of the second optical face 33 or also the plane best fitted to the second optical face 33 by a first-order regression.

Therefore, in this second embodiment, the lens 31 generates almost no astigmatism because the two radii of curvature Rx, Ry are coplanar.

Here, as illustrated in FIG. 7, the second optical face 33 extends along a toroidal surface. The second optical face 33 then corresponds for example to a part of a surface generated by the rotation of a circle whose radius is equal to the first radius of curvature Rx around a straight line located at a distance equal to the second radius of curvature Ry. The above-mentioned part here depends on the shape of the peripheral edge 34, it is for example square or circular.

In this second embodiment, to shape the amplified beam 4 shown in FIGS. 1 and 2 (which is divergent in the first plane Px and convergent in the second plane Py), the second optical face 33 is thus both convex and concave. The second optical face 33 is more particularly convex in the first plane Px and concave in the second plane Py. The second optical face 33 then extends along a surface part of an open torus, which is located opposite the axis of rotation of the torus.

The first optical face 32 is preferably perpendicular to the propagation direction D.

Whatever the embodiment, the lens 31 is here made of silica. The lens 31 can also be made of another optical glass, such as the flint or the crown. The lens 31 is here made from electronic grade silica (SiO₂). This makes it possible to reduce the inclusions that might be present in the lens 31 and contribute to its heating when illuminated by the amplified beam 4. The OH ion content of the lens is preferably low, e.g. less than 1000 ppm, so that the lens absorbs very little infrared radiation, which limits its heating.

Here, the lens 31 is made of a silica with an absorption of less than 10⁻⁵ cm⁻¹ ppm for a wavelength of between 900 nm and 1100 nm. As the infrared range is a preferred operating range for laser systems, it is advantageous for the lens 31 to have low absorption in this range. Here, the heating of the lens 31 is therefore greatly limited when the amplified beam 4 is in the above-mentioned wavelength range.

The lens 31 is here manufactured using computer numerically controlled machining, also called “CNC” machining, which makes it possible to make complex optical faces, for example a toroidal surface such as that of the second embodiment, with a high precision. The manufacture by computer numerically controlled machining makes it possible in particular to shape spherical, aspherical or free-form surfaces. After machining, the optical faces 32, 33 are polished so that the roughness is less than a quarter of the central wavelength. According to the MIL-PRF-13830B standard, the optical faces 32, 33 are polished so that the scratch and the dig are included between 10 and 20. ***the French translations of the parameters and their values seem correct to you?***

The lens 31 can also be treated by applying coatings on its optical faces 32, 33. The lens 31 comprises for example one of the following coatings: anti-reflective, nano-structured coating. Preferably, the anti-reflective coating has a reflectance at normal incidence of less than 0.1 % at 1030 nm. The coatings are deposited after the polishing.

The present invention is not in any way limited to the embodiments described and shown, but the person skilled in the art will know how to apply any variant in accordance with the invention. For example, the amplified beam can be divergent (between the amplifying medium and the optical device) both in the first plane and in the second plane. That is for example the case when the amplifying medium corresponds to that of a laser diode. For such an amplified beam, it is then provided that the lens has two positive focal lengths. When the divergence of such an amplified beam is not the same in the first or the second plane, it then also has a circularity section at which the lens is preferably positioned. When the amplifying medium corresponds to that of a laser diode, the radii of curvature are for example of between 1 mm and 1000 mm.

1. A laser system comprising:
a solid amplifying medium capable of emitting an amplified beam along a propagation direction the amplified beam having a first angle of divergence in a first plane including the propagation direction, and a second angle of divergence in a second plane including the propagation direction and distinct from the first plane the second angle of divergence being distinct from the first angle of divergence and
an optical device
characterized in that the optical device comprises a lens arranged so as to refract the amplified beam into an outgoing beam the lens having a first radius of curvature in the first plane and a second radius of curvature in the second plane the second radius of curvature being distinct from the first radius of curvature

2. The laser system according to claim 1, wherein the outgoing beam has two angles of divergence in the first plane and in the second plane, respectively, and wherein the first radius of curvature and the second radius of curvature are determined, on the basis of the first angle of divergence and the second angle of divergence, so as to meet at least one of the following criteria:
a difference between the two angles of divergence of the outgoing beam is less that a first threshold value;
at least one among the two angles of divergence of the outgoing beam is less than a second threshold value.

3. The laser system according to claim 1, wherein the first radius of curvature and the second radius of curvature are determined in such a way that the outgoing beam is less astigmatic than the amplified beam.

4. The laser system according to claim 1, wherein the amplified beam has a circularity section perpendicular to the propagation direction in which the amplified beam is circular in shape, and wherein the lens is positioned in such a way as to intersect the circularity section

5. The laser system according to claim 1 4, wherein the first plane is perpendicular to the second plane.

6. The laser system according to claim 1, wherein, between the amplifying medium and the optical shaping device the amplified beam is divergent in the first plane and convergent in the second plane

7. The laser system according to claim 1, wherein the lens comprises:
a first optical face forming the first radius of curvature and
a second optical face opposite to the first optical face forming the second radius of curvature.

8. The laser system according to claim 7, wherein at least one among the first optical face and the second optical face extends along a cylindrical surface of revolution.

9. The laser system according to claim 1, wherein the lens comprises:
a first flat optical face and
a second optical face opposite to the first optical face forming the first radius of curvature and the second radius of curvature

10. The laser system according to claim 9, wherein the second optical face extends along a toroidal surface.

11. The laser system according to claim 1, wherein the first radius of curvature and the second radius of curvature are each comprised between 1 mm and 1000 mm.

12. The laser system according to claim 1, wherein the amplified beam comprises a central wavelength, and wherein the lens comprises optical faces whose roughness is less than a quarter of the central wavelength.

13. The laser system according to claim 1, wherein the lens is made of a silica with an absorption of less than 10⁻⁵ cm⁻¹ for a wavelength comprised between 900 nm and 1100 nm.

14. The laser system according to claim 1, wherein the amplified beam has a Gaussian profile in a transverse direction perpendicular to the propagation direction.

15. The laser system according to claim 1, wherein the optical shaping device is consisted of the lens.
